(19) United States
(12) Patent Application Publication
(10) Pub. No.: US 2014/0379124 A1
(43) Pub. Date: Dec. 25, 2014

(54) METHOD AND APPARATUS FOR DISTRIBUTING HELMETS

(71) Applicant: PBSC Solutions Urbaines Inc., Longueuil (CA)

(72) Inventor: Michel DALLAIRE, Montreal (CA)

(21) Appl. No.: 14/309,471

(22) Filed: Jun. 19, 2014

Related U.S. Application Data
(60) Provisional application No. 61/836,708, filed on Jun. 19, 2013.

(51) Int. Cl. G07F 11/00; A42B 3/04; G07F 17/00; A42B 3/00

(52) U.S. Cl. CPC G07F 11/002; A42B 3/00; A42B 3/0433; G07F 17/0057
USPC 700/237

(57) ABSTRACT

A method for providing a helmet to a user includes receiving a request from a user for performing one of renting and buying a helmet. The request includes an indication of a size for the helmet; determining if the request can be met by a helmet dispensing apparatus and authenticating the user. If the authentication is successful, the helmet dispensing apparatus provides the user with a helmet in accordance with the request. The helmet includes an identification element and the providing includes associating the identification element of the helmet provided with the user.

This application claims benefit of Ser. No. 61/836,702, filed 19 Jun. 2013 in the United States and which application is incorporated herein by reference. To the extent appropriate, a claim of priority is made to the above disclosed application.

### FIELD OF THE INVENTION

This application relates to apparatus for providing goods. More precisely, the patent application pertains to a method and apparatus for distributing helmets.

### BACKGROUND OF THE INVENTION

Bicycle sharing systems are now very popular in many cities around the world. These bicycle sharing systems offer flexible ways for individuals to commute.

While it is commonly advised to wear a helmet, some cities have enacted bylaws requiring users to wear them. An occasional user of a bicycle sharing system may not necessarily own a helmet, nor would a tourist visiting a city offering this service.

There is a need for a method and system for distributing helmets.

### BRIEF SUMMARY OF THE INVENTION

According to a broad aspect, there is disclosed a method for providing a helmet to a user, the method comprising receiving a request from a user for performing one of renting and buying a helmet, the request comprising an indication of a size for the helmet; determining if the request can be met by a helmet dispensing apparatus; authenticating the user and if the authentication is successful, the helmet dispensing apparatus providing the user with a helmet in accordance with the request, the helmet comprising an identification element, the providing comprising associating the identification element of the helmet provided with the user.

In accordance with another object, there is provided a helmet providing unit, said helmet providing unit including a plurality of helmets, and an interface for receiving from a user a request to rent or purchase one of said plurality of helmets;

said helmet providing unit further including an authorizing module for authorizing said user to purchase or rent said helmet;

said helmet providing unit including a helmet dispenser for dispensing said helmet when said user has been authorized.

Yet another aspect of the invention concerns a system for providing helmets to users, said system including a plurality of helmets providing units geographically distributed in an area;

said helmet providing units being adapted to receive a report from a user to rent or purchase a helmet; each of said units being in communication with a remote location and with each other directly or through said remote location, said helmet providing units being provided with a user interface and an authorizing module;

said helmet providing units including a dispenser for dispensing a helmet when a user has been authorized;

said system further including at least one helmet collecting station.

### BRIEF DESCRIPTION OF THE DRAWINGS

In order that the invention may be readily understood, embodiments of the invention are illustrated by way of example in the accompanying drawings.

FIG. 1 is a flowchart that shows an embodiment of a method for providing helmets. According to a first step, a request is received from a user for performing one of renting and buying a helmet. According to a second step, a test is performed to determine if the request can be made, and, according to a third step, the user is provided with the helmet if the request can be met.

FIG. 2 is a flowchart that shows a first embodiment of the receiving of a request from a user for performing one of renting and buying a helmet and determining if the request can be met.

FIG. 3 is a flowchart that shows an embodiment for performing an authentication.

FIG. 4 is a flowchart that shows a second embodiment of the receiving of a request from a user for performing one of renting and buying a helmet and determining if the request can be met.

FIG. 5 is a flowchart that shows an embodiment for displaying helmet availability in surrounding helmet providing units.

FIG. 6 is a flowchart that shows an embodiment for providing the user with the helmet if the request can be met. According to a first step, a motor is actuated, according to a second step, a helmet position is detected, according to a third step, a helmet identification is transmitted, and, according to a fourth step, the helmet is provided.

FIG. 7 is a flowchart that shows an embodiment for transmitting the helmet identification. According to a first step, an RFID tag is read, according to a second step, the RFID tag is associated with user information and according to a third step, the data is provided to a remote processing unit.

FIG. 8 is a flowchart that shows an embodiment for providing the helmet.

FIG. 9 is a diagram that shows a system for providing a helmet.

FIG. 10A is a front, top, right, perspective view of one embodiment of a helmet providing unit.

FIG. 10B is a front, top, right, perspective view of one embodiment of a helmet providing unit with a helmet retrieving basket removed.

FIG. 11 is a front, top, right, perspective view of one embodiment of a helmet providing unit with a helmet retrieving basket and a vertical front panel removed.

FIG. 12 is a back, top, right, perspective view of one embodiment of a helmet providing unit with a part of the frame removed.

FIG. 13 is a back, top, right, perspective view of one embodiment of a helmet providing unit with a part of the frame and a helmet tray removed.

FIG. 14 shows a perspective view and also a top plan view of a helmet tray.

FIG. 15 is a back, top, left, perspective view of one embodiment of the helmet providing unit with a part of the frame removed.

FIG. 16 is an enlarged, back, top, left, perspective view of one part of the helmet providing unit showing actuating means on two helmet trays.

FIG. 17 is a back, top, left, perspective view of one embodiment of the helmet providing unit with a part of the frame, the vertical front panel and a top helmet tray removed.

FIG. 18 is a front, top, right, perspective view of one embodiment of a helmet collecting station.

FIG. 19 is a front, top, right, perspective and partly exploded view of one embodiment of a helmet collecting station.

FIG. 20 shows a first right-side elevation and cross-section view taken along lines AA of a helmet collecting station in which a helmet is inserted through an access door into a cavity and a second right side elevation and cross-section view taken along lines AA of the helmet collecting station in which an access door is closed with a helmet in the cavity.

FIG. 21 shows how a helmet may be provided to the helmet collecting station.

Further details of the invention and its advantages will be apparent from the detailed description included below.

### DETAILED DESCRIPTION OF THE INVENTION

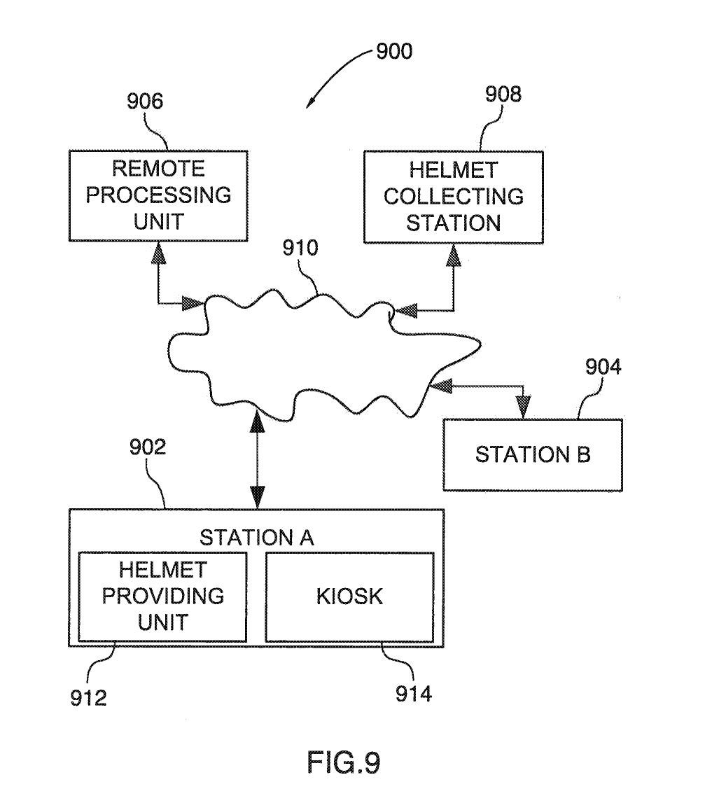

Now referring to FIG. 9, there is shown an embodiment of a system for providing helmets.

It will be appreciated that the system for providing helmets may be advantageously used in combination with a bicycle sharing system.

In fact, the skilled addressee will appreciate that the bicycle sharing system may be of various types.

In a preferred embodiment, the bicycle sharing system is the Bixi™ system that was developed by the applicant and that has been successfully deployed in many cities throughout the world.

The system for providing helmets comprises a plurality of stations. Each of the plurality of stations, for instance station A 902 and station B 904, comprises at least one helmet providing unit 912 and a kiosk 914. In one embodiment, a plurality of helmet providing units are provided in a given station.

It will be appreciated that preferably bicycles and corresponding bicycle docking stations are also provided at each station. As such, a user will be able to obtain quickly both a bicycle and a helmet.

The kiosk 914 is used for obtaining an order code. It will be appreciated that the order code is used when a user is not registered in the system. In such case, the order code is entered by the user at a helmet providing unit in order to obtain a helmet.

It will be appreciated that an unregistered user is an individual willing to use the system but who does not have a subscription. For instance, an unregistered user in the system may be a tourist visiting a city.

Accordingly and as further explained below, an unregistered user in the system may go to the kiosk 914 of the station A 902 in order to obtain an order code following the use of a credit card, and then obtain the helmet at the helmet providing unit 912 of station A 902.

In one embodiment, the order code is a generated number comprising five digits between 1 and 3. The skilled addressee will appreciate that alternative embodiments may be possible.

It will be appreciated that the order code is valid for a limited amount of time.

In one embodiment, the amount of time is 5 minutes.

The remote processing unit 906 is used to store identification data of all registered users and unregistered users using the system, as well as a corresponding helmet identification and its location when it is in one of a helmet collecting station and a helmet providing unit.

The identification data of a registered user may comprise registration data such as name, phone number, address, credit card number, identification of a subscription key, etc.

The identification data of an unregistered user may comprise a credit card number used to interact with the system and a time and date of first use, etc.

The remote processing unit 906 is also used to handle a processing of a payment in the case of an unregistered user. In fact, it will be appreciated that an unregistered user will pay a nominal fee for a given time period. In one embodiment, the given time period is one day.

The helmet collecting station 908 is used to receive a helmet following the end of rental of the helmet by the user. It will be appreciated that a plurality of helmet collecting stations exist at any given location.

As further explained below, a user may decide either to keep a helmet or bring it back within a given time frame at the helmet collecting station 908.

More precisely, the helmet collecting station 908 comprises means for identifying a helmet being returned to the helmet collecting station 908.

In an embodiment, these identification means comprise an RFID reader adapted to read a corresponding RFID helmet identification.

The helmet collecting station 908 is further capable of reporting to the remote processing unit 906.

Each of the remote processing unit 906, the helmet collecting station 908, the station A 902 and the station B 904 are operatively connected together via the data network 910, and can communicate with each other either directly or through remote processing unit 906.

The skilled addressee will appreciate that various alternative configurations may be provided for achieving such connection.

In fact, it will be appreciated that the data network 910 may be of various embodiments. In one embodiment, the data network 910 comprises at least one of a local area network (LAN), a wide area network (WAN) and a metropolitan area network (MAN).

In one embodiment, the data network 910 comprises the Internet.

In an alternative embodiment, the helmet providing unit 912 is operatively connected to the kiosk 914 through one of a wire and a wireless connection. Also, the helmet collecting station 908 and the kiosk 914 may be operatively connected together using one of a wire and a wireless connection.

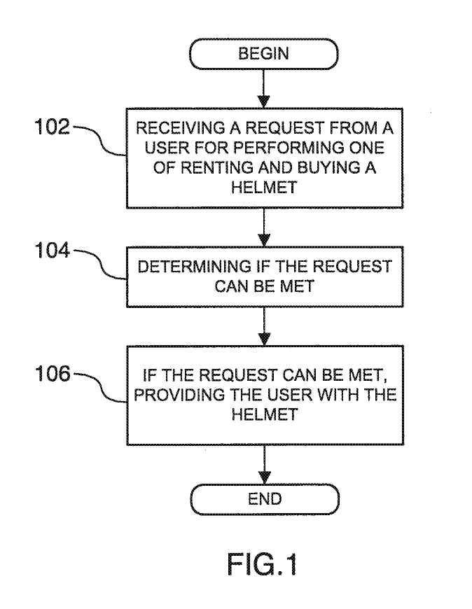

Now referring to FIG. 1, there is shown a first embodiment of a method for providing a helmet.

According to processing step 102, a request is received from a user for performing one of renting and buying a helmet. It will be appreciated by the skilled addressee that the request may be received according to various embodiments, as further shown below.

According to processing step 104, a determination is performed to find out if the request can be met.

According to processing step 106, the user is provided with the helmet if the request can be met.

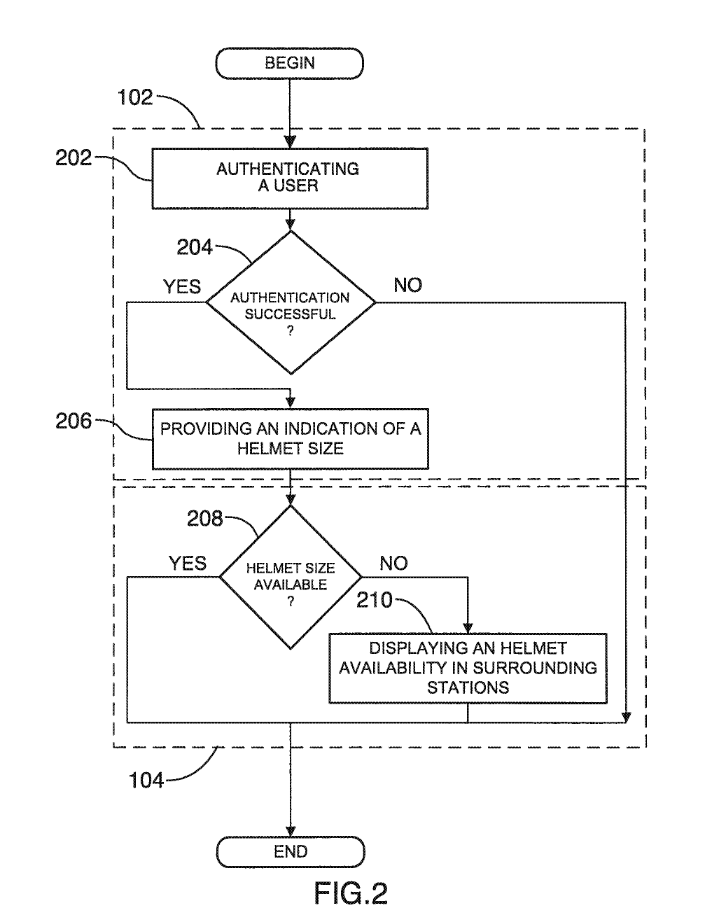

Now referring to FIG. 2, there is shown a first embodiment of processing steps 102 and 104. It will be appreciated that this first embodiment corresponds to the case wherein a user is already registered in the system. It will be appreciated that the user may be registered in the system according to the various embodiments, as further explained below.

According to processing step 202, a user is authenticated.

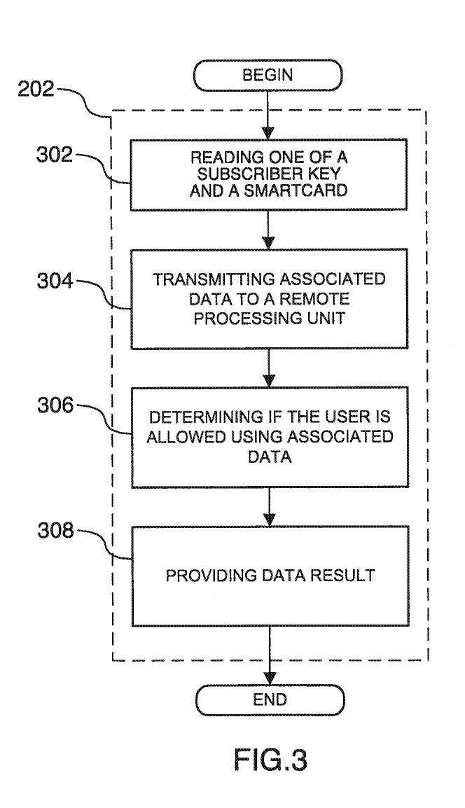

Now referring to FIG. 3, there is shown a first embodiment for performing the authentication.

According to processing step 302, one of a subscriber key and a smart card is read.

According to processing step 304, associated data related to one of the subscriber key and the smart card are transmitted to the remote processing unit 906. It will be appreciated that the remote processing unit 906 comprises, inter alia, a database of registered users as mentioned above.

According to processing step 306, a check is performed by the remote processing unit 906 to find out if the user is allowed to use the system. It will be appreciated that the determination is performed using the associated data transmitted.

According to processing step 308, the data result is provided.

Now referring back to FIG. 2 and according to processing step 204, a test is performed to find out if the authentication is successful.

In the case where the authentication is successful and in accordance with processing step 206, the user can provide an indication of a helmet size required.

It will be appreciated that in one embodiment two helmet sizes (i.e., small size and large size) are available to a user. The reader will appreciate that two sizes are more easily managed. However, specific circumstances may require that the helmet providing unit may include more than two sizes, such as e.g. small, large and child). Other combinations will be readily apparent.

According to processing step 208, a test is performed to find out if a helmet with the selected helmet size is available at the helmet providing unit.

The test is performed using the indication of the helmet size provided by the user. In fact, it will be appreciated by the skilled addressee that, while up to 32 helmets may be stored at a given helmet providing unit, a given size of the two sizes may not be available anymore due to user demand. The skilled addressee will appreciate that in alternative embodiments a greater amount of helmets may be provided.

In the case where the helmet size is not available and according to processing step 210, helmet availability in surrounding helmet providing units is advantageously displayed to the user. The skilled addressee will appreciate that this is of great advantage in order to enable a user to readily find an alternative solution to obtain the suitable helmet. It will be appreciated that the helmet availability may be provided at at least one of a kiosk; a helmet provided unit, a user mobile application, etc.

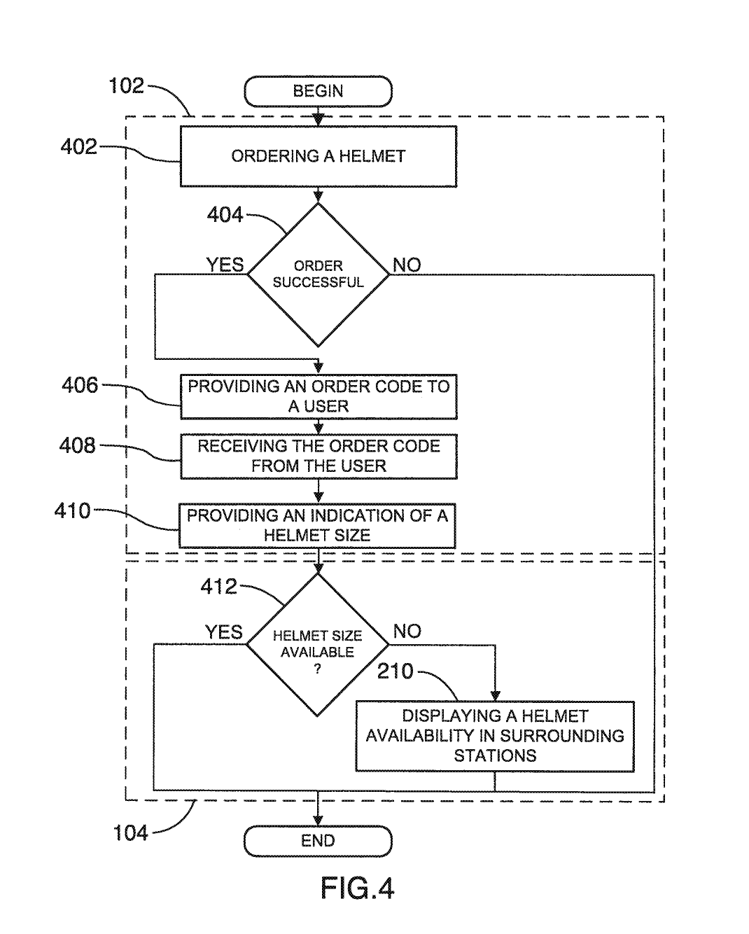

Now referring to FIG. 4, there is shown another embodiment for receiving the request from a user for performing one of renting and buying a helmet and determining if the request can be made.

In fact, in this embodiment, the user is not registered in the system. In such case, the user will order a helmet according to processing step 402. The ordering of the helmet will be performed at a kiosk, such as at kiosk 914.

The ordering of the helmet will comprise providing a payment card such as a credit card, a debit card, a transit card, etc. According to processing step 404, a test will be performed in order to find out if the order is successful.

It will be appreciated by the skilled addressee that a credit card payment may pass or fail depending on various criteria.

In the case where the order is successful, and according to processing step 406, an order code will be provided to a user. The order code may be used for a given period of time as explained above.

In one embodiment, the given period of time is five minutes.

During that given period of time, the user may enter the order code at a helmet providing unit according to processing step 408.

The order code will be entered using a keypad located at a control panel in an embodiment.

According to processing step 410, the user will then provide an indication of a helmet size.

According to processing step 412, a test will be performed in order to find out if the helmet size required by the user is available.

In the case where a helmet of the helmet size selected is not available and in accordance with processing step 210, a helmet availability in surrounding helmet providing units will be displayed to the user. The helmet availability in surrounding helmet providing units will be displayed according to various embodiments.

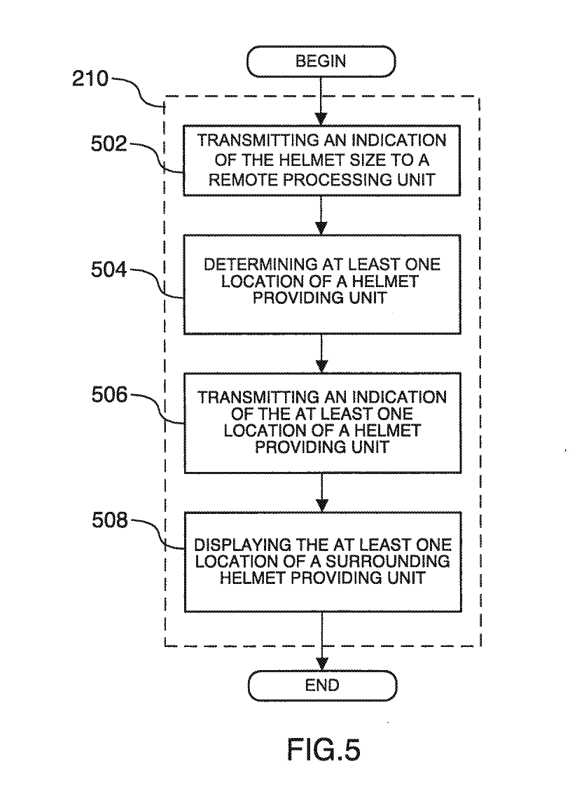

Now referring to FIG. 5, there is shown an embodiment for displaying helmet availability in surrounding helmet providing units.

According to processing step 502, an indication of the helmet size is transmitted to a remote processing unit 906.

It will be appreciated that the remote processing unit 906 will comprise, inter alia, a list of helmet size availabilities in each of the helmet providing units.

According to processing step 504, at least one location of a helmet providing unit for providing the helmet of the helmet size selected will be determined. The skilled addressee will appreciate that the determination may be based on various criteria.

One of the criteria may comprise a distance between a helmet providing unit where the user is and another helmet providing unit.

According to processing step 506, an indication of the at least one location of a helmet providing unit is transmitted to the helmet providing unit.

According to processing step 508, the at least one location of a helmet providing unit is displayed to a user.

Now referring back to FIG. 1 and according to processing step 106, the user is provided with the helmet if the request can be met.

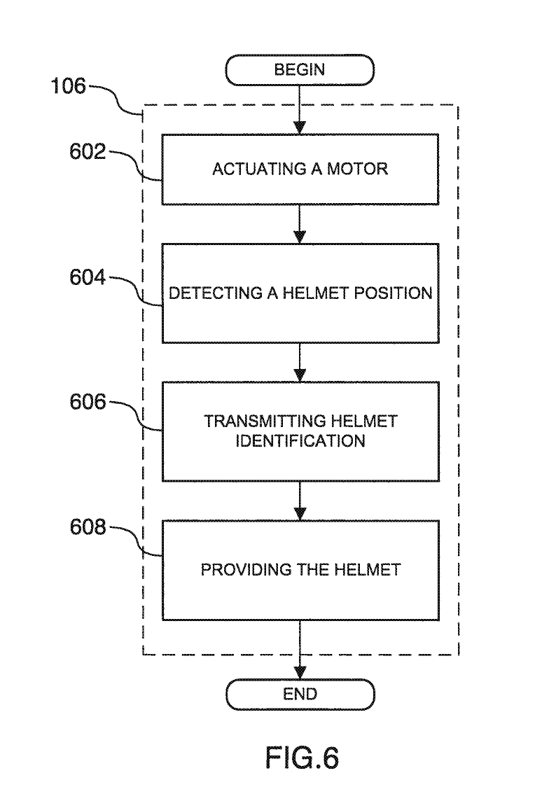

In fact, and as shown in FIG. 6, in one embodiment the user may be provided with the helmet according to various embodiments. In this particular embodiment, and according to processing step 602, a motor is actuated.

The motor is actuated to move a given helmet in a helmet chute as further explained below.

According to processing step 604, a helmet position is detected. The helmet position is detected in the helmet chute when the helmet falls down. It will be appreciated that the detecting of the helmet position will comprise obtaining an identification of the helmet. The helmet identification may be provided according to various embodiments.

According to processing step 606, the helmet identification is transmitted. The helmet identification may be provided according to various embodiments.

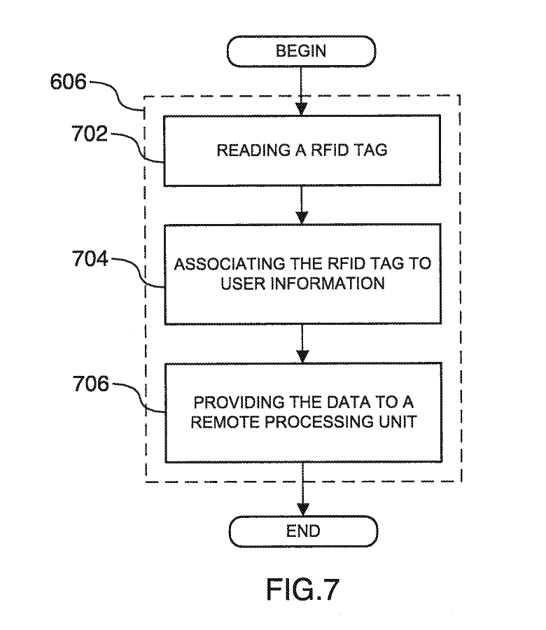

Now referring to FIG. 7, there is shown an embodiment for providing a helmet identification.

According to processing step 702, a RFD tag is read. In this embodiment, the RFID tag is integrated into the helmet and it is used uniquely to identify a given helmet.

According to processing step 704, the RFID tag is associated with the user information.

It will be appreciated that the association is performed either with an identification of a registered user or with payment data of the user if the user is not registered in the system.

According to processing step 706, the data is provided to the remote processing unit 906.

Now referring back to FIG. 6 and according to processing step 608, the helmet is provided to the system.

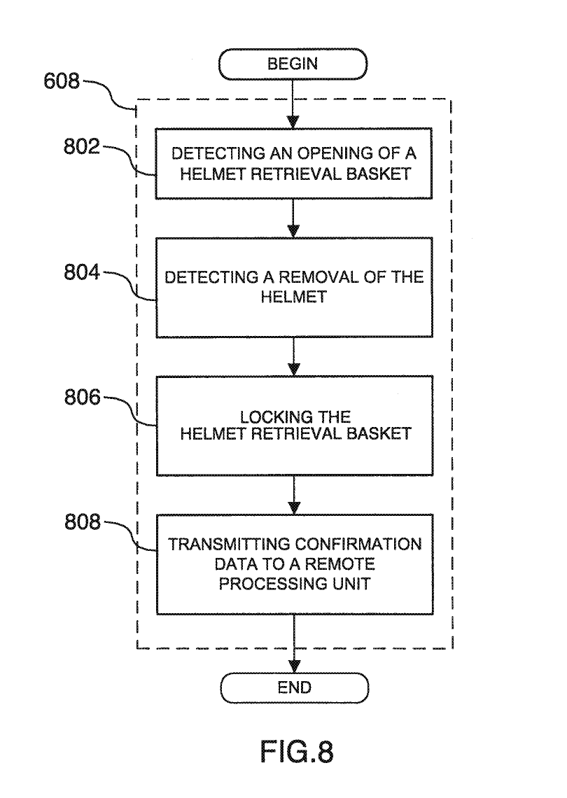

Now referring to FIG. 8, there is shown an embodiment for providing the helmet.

According to processing step 802, an opening of a helmet retrieval basket is detected. The opening of the helmet retrieval basket is performed following an unlocking of the helmet retrieval basket.

It will be appreciated that the opening is performed by a user wishing to obtain his/her helmet.

A detection of a removal of the helmet from the helmet retrieval basket is further performed according to processing step 804. The skilled addressee will appreciate that the removal of the helmet may be detected according to various embodiments.

According to processing step 806, the helmet retrieval basket is locked following the removal of the helmet.

The skilled addressee will appreciate that this may be of great advantage in order to avoid unauthorized opening of the helmet retrieval basket.

According to processing step 808, confirmation data is transmitted to the remote processing unit 906.

The purpose of transmitting the confirmation data is to validate that the given user has successfully obtained the helmet and that this given helmet is no longer available. Following that, it will be appreciated that the user may return the helmet to the helmet collecting station 908. It will be appreciated that, if the helmet is not returned to the helmet collecting station 908 during a given time period, the helmet will be considered to have been bought by the user. The user will then be charged a fee for that purpose.

In one embodiment, the user will be charged the fee if the helmet is not returned within 24 hours or within the specified period for rental.

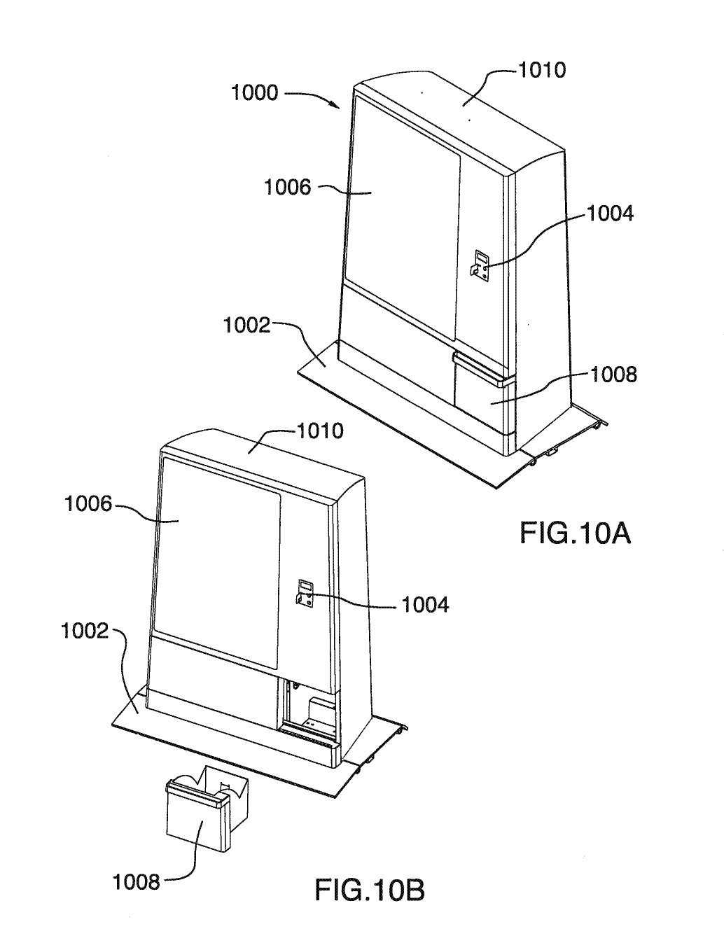

Now referring to FIGS. 10A and 10B, there is shown an embodiment of a helmet providing unit 1000.

The helmet providing unit 1000 comprises a frame 1010, a control panel 1004 and a helmet retrieving basket 1008.

It will be further appreciated that the helmet providing unit 1000 further comprises a panel 1006. The panel 1006 is opaque. It will be appreciated that the panel 1006 offers an area that could be used for providing ads, information, maps, etc., which could be protected or not using a transparent panel.

In one embodiment, the helmet providing unit 1000 is mounted on an elongated base 1002 using fastening members, not shown.

In one embodiment, the elongated base used is one already used by the bicycle sharing system.

The skilled addressee will appreciate that this will enable an integration of the system disclosed herein for providing helmets in an existing bicycle sharing system.

The control panel 1004 is used for ordering a helmet. It will be appreciated that a helmet may be ordered via the control panel 1004 using either an order code, a subscriber key or a smart card.

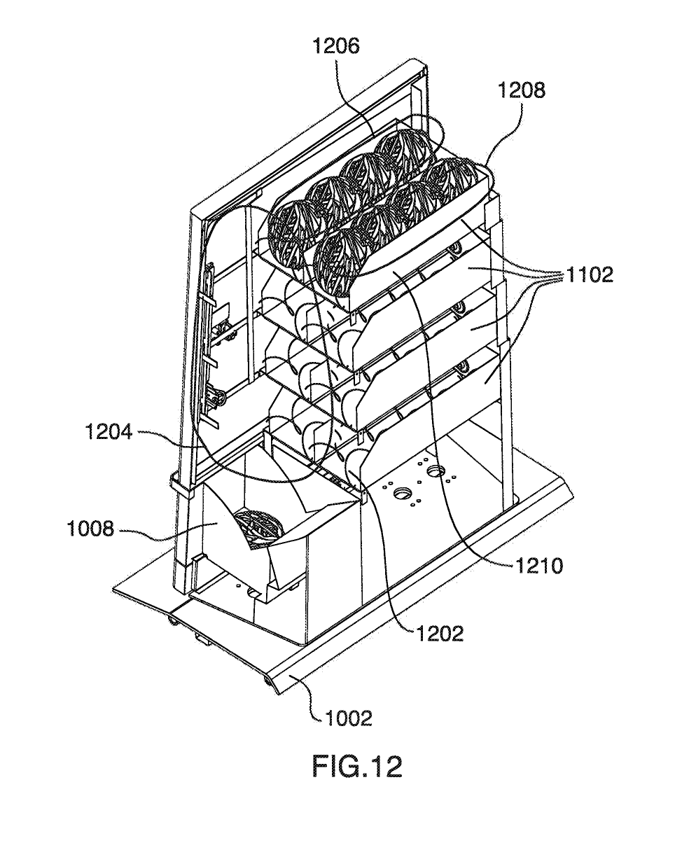

Now referring to FIG. 12, there is shown more details on the inside of the helmet providing unit 1000.

As shown, the helmet providing unit 1000 comprises a plurality of helmet trays 1102 secured inside the frame 1010 of the helmet providing unit 1000.

It will be appreciated that the plurality of helmet trays are arranged in a stack. Such configuration enables the creation of a helmet chute 1204 at one end of the stack formed by the plurality of helmet trays 1102.

It will be appreciated that the helmet retrieving basket 1008 is located at the bottom of the helmet chute 1204 and is therefore used for collecting a helmet falling in the helmet chute 1204.

It will be appreciated that a helmet may be placed in the helmet chute 1204 as a result of an actuation of an actuating means, not shown, in a corresponding helmet tray of the plurality of helmet trays 1102.

Still referring to FIG. 12, it will be appreciated that a stack of four trays is provided.

Still in the embodiment shown in FIG. 12, it will be appreciated that a given tray, for instance helmet tray 1210, is capable to receive two rows, i.e., first helmet row 1206 and second helmet row 1208, of helmets. Each of the first helmet row 1206 and the second helmet row 1208 comprises four helmets.

It will be appreciated that various alternative embodiments may be provided.

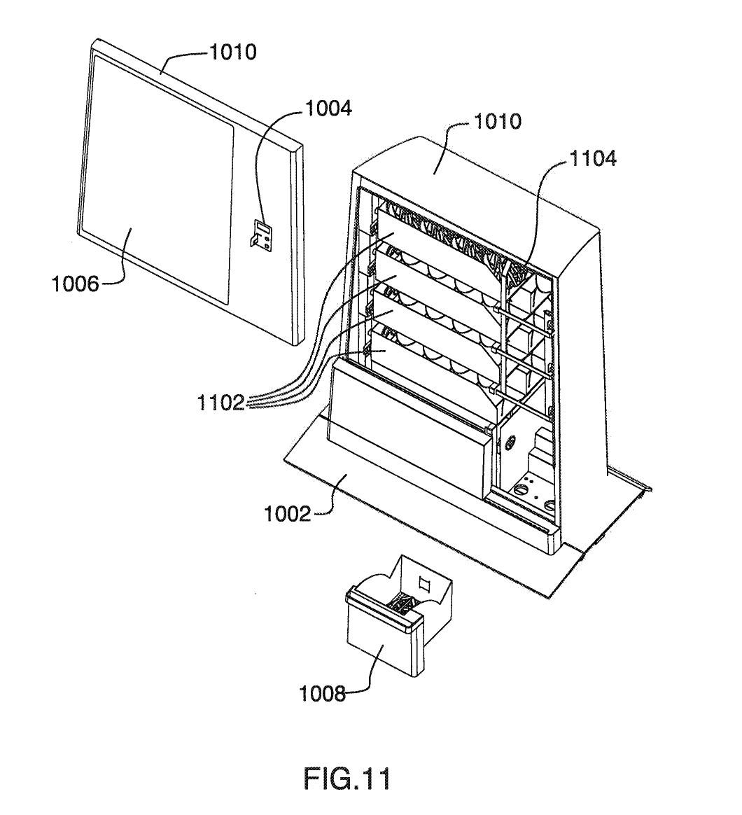

Now referring to FIG. 11, there is shown an embodiment of the helmet providing unit 1000 with a vertical front panel 1010 and the helmet retrieving basket 1008 removed.

The vertical front panel 1010 comprises the panel 1006 and the control panel 1004.

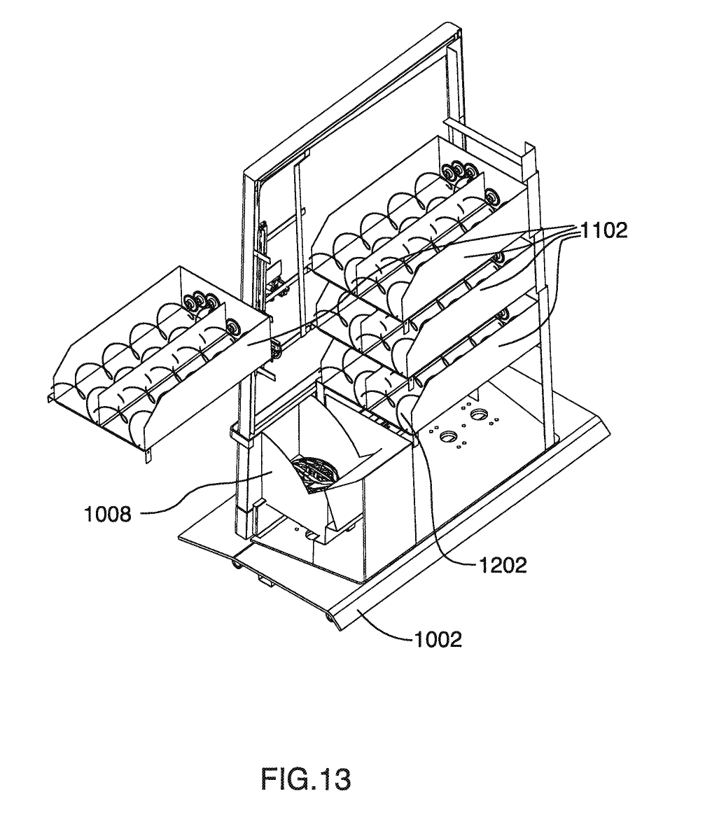

Now referring to FIG. 13, there is further shown the plurality of helmet trays 1102 with one removed.

It will be appreciated that two endless helical screws are provided on each row of each helmet tray. Alternatively, it will be appreciated that one endless helical screw could be used for each row.

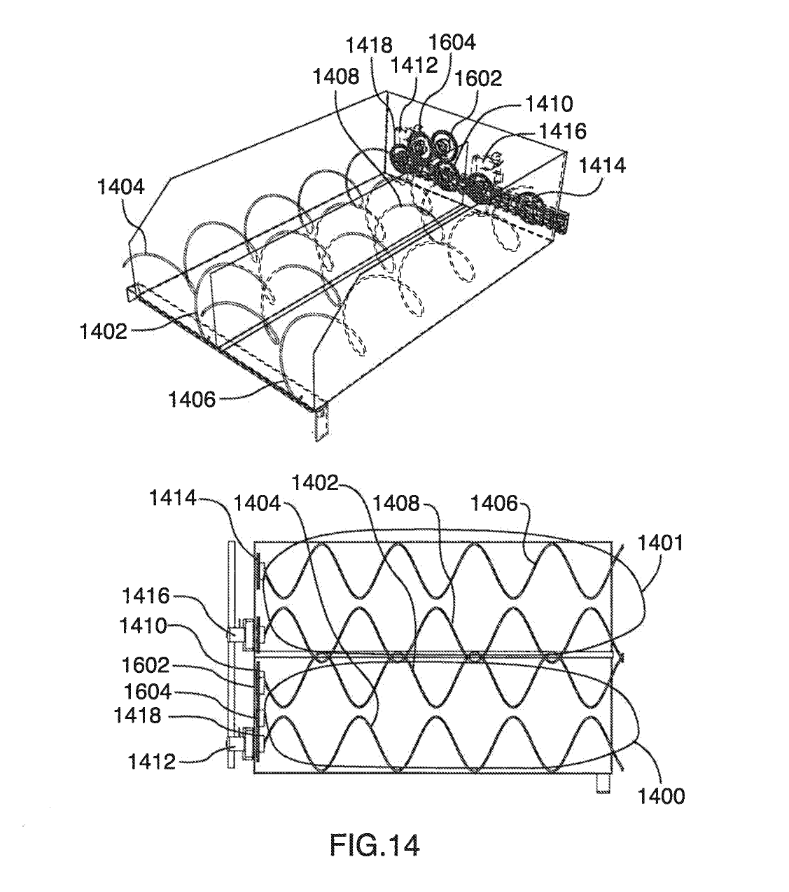

Now referring to FIG. 14, there is shown a helmet tray of the plurality of helmet trays.

A first row 1400 of the helmet tray comprises a first endless helical screw 1402 and a second endless screw 1404 while a second row 1401 of the helmet tray comprises a first endless helical screw 1406 and a second endless helical screw 1408.

The first endless helical screw 1402 is actuated by an actuating means 1410, an embodiment of which is a sprocket 1410.

The second endless helical screw 1404 is actuated by an actuating means 1412, an embodiment of which is a motor 1412.

It will be appreciated that the sprocket 1410 and the motor 1412 are operatively coupled together as further shown below.

It will be appreciated that in one embodiment, the coupling is achieved using other sprockets. The skilled addressee will appreciate that various alternative embodiments may be provided.

The first endless helical screw 1406 is actuated by an actuating means 1414, an embodiment of which is a sprocket 1414.

The second endless helical screw 1408 is actuated by an actuating means, an embodiment of which is a motor 1416.

It will be appreciated that the sprocket 1414 and the motor 1416 are operatively coupled together as further shown below. It will be appreciated that in one embodiment, the coupling is achieved using other sprockets. The skilled addressee will appreciate that various alternative embodiments may be provided.

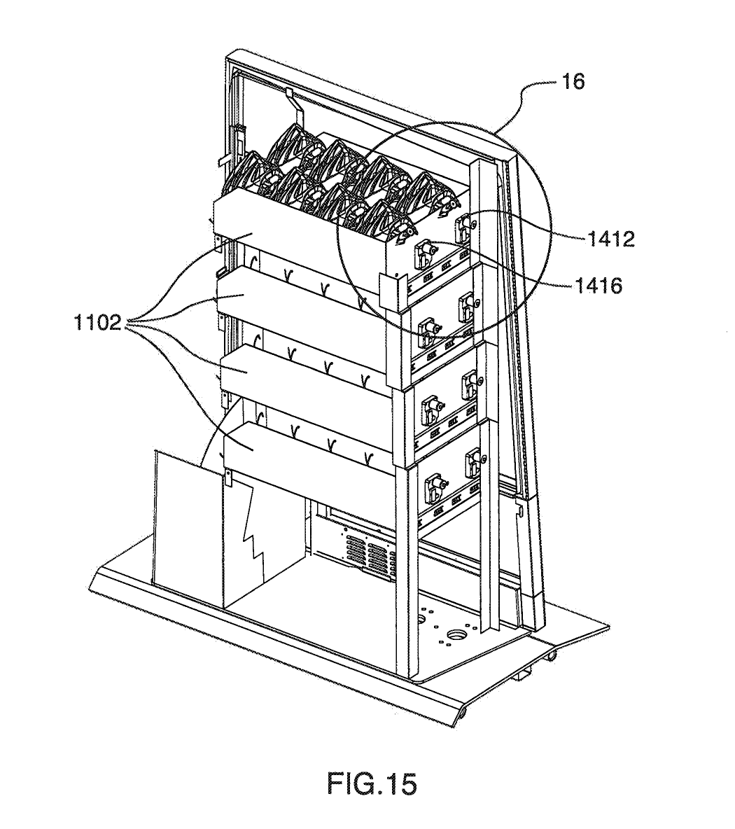

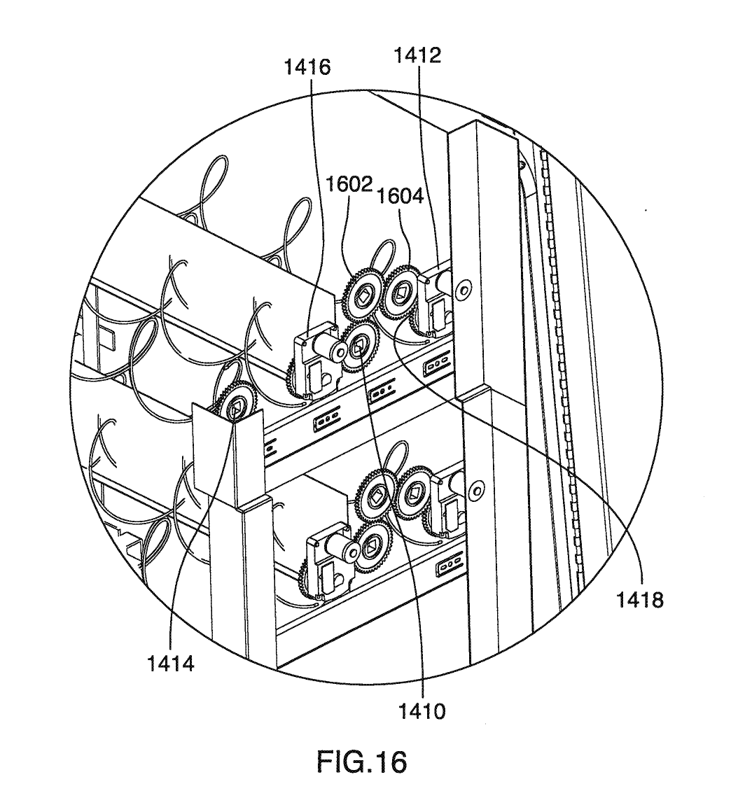

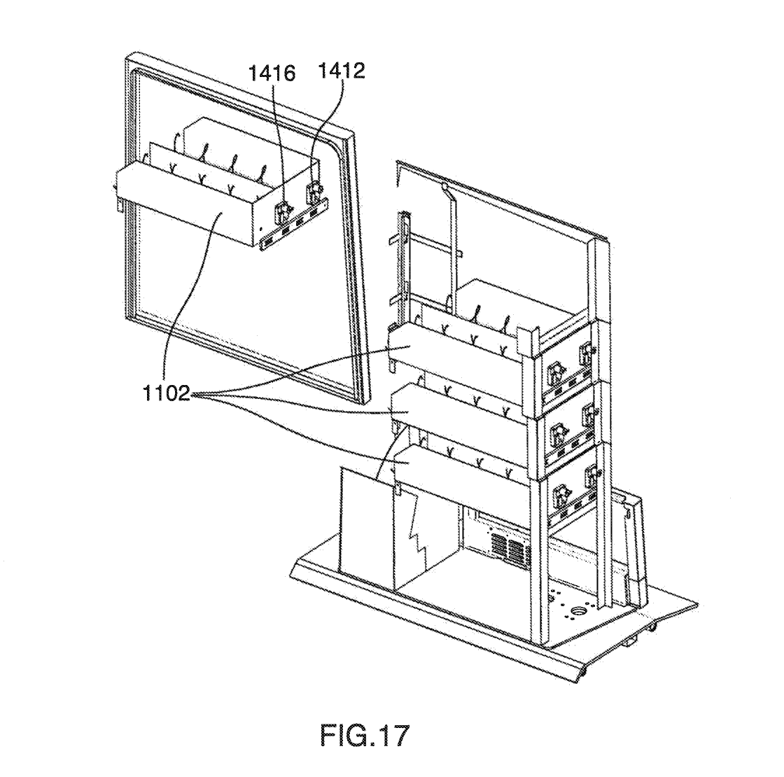

Now referring to both FIGS. 15 and 16, there is shown how the sprocket 1410 and the motor 1412 are operatively coupled together.

More precisely, a first connecting sprocket 1602 and a second connecting sprocket 1604 are used.

The sprocket 1410 is operatively connected to the first connecting sprocket 1602.

The first connecting sprocket 1602 is connected to a second connecting sprocket 1604.

The second connecting sprocket 1604 is operatively connected to a sprocket 1418. The sprocket 1418 is axially engaged to the motor 1412. The skilled addressee will appreciate that alternative embodiments may be provided.

While this has not been shown in the figures, it will be appreciated that the helmet providing unit 1000 further comprises means for detecting a chute of a helmet in the helmet retrieving basket 1008 and means for identifying the corresponding helmet.

The helmet providing unit 1000 further comprises means for selectively locking/unlocking the helmet retrieving basket 1008.

The helmet providing unit 1000 further comprises means for transmitting data to the remote processing unit, the data comprising at least an identification of the helmet placed in the helmet retrieving basket 1008.

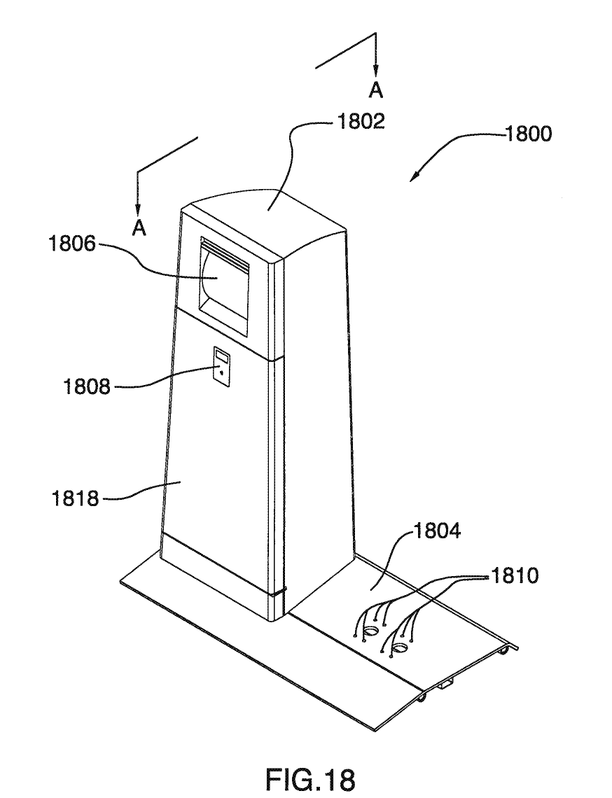

Now referring to FIG. 18, there is shown an embodiment of a helmet collecting station 1800.

The helmet collecting station 1800 comprises a frame 1802, an access door 1806 and a control panel 1808.

It will be appreciated that the helmet collecting station 1800 is mounted on an elongated base 1804 using fastening members engaged in members 1810 of the elongated base 1804.

The control panel 1808 is used for enabling a user to provide a helmet in the helmet collecting station 1800.

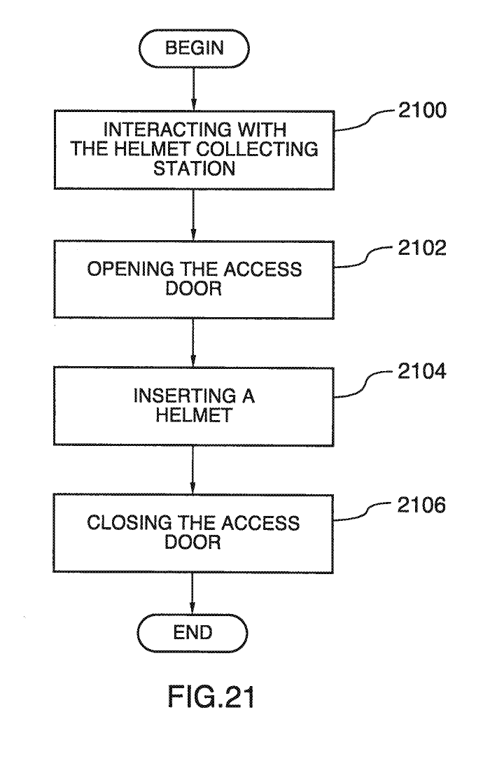

As shown in FIG. 21 and in accordance with processing step 2100, it will be appreciated that a helmet may be provided back by first interacting with the control panel 1808 using either a reading of the helmet RFD tag, an order code, a subscriber key or a smart card. According to processing step 2102, the access door 1806 may be then opened by a user. According to processing step 2104, a helmet may then be inserted and according to processing step 2106 the access door 1806 may then be closed.

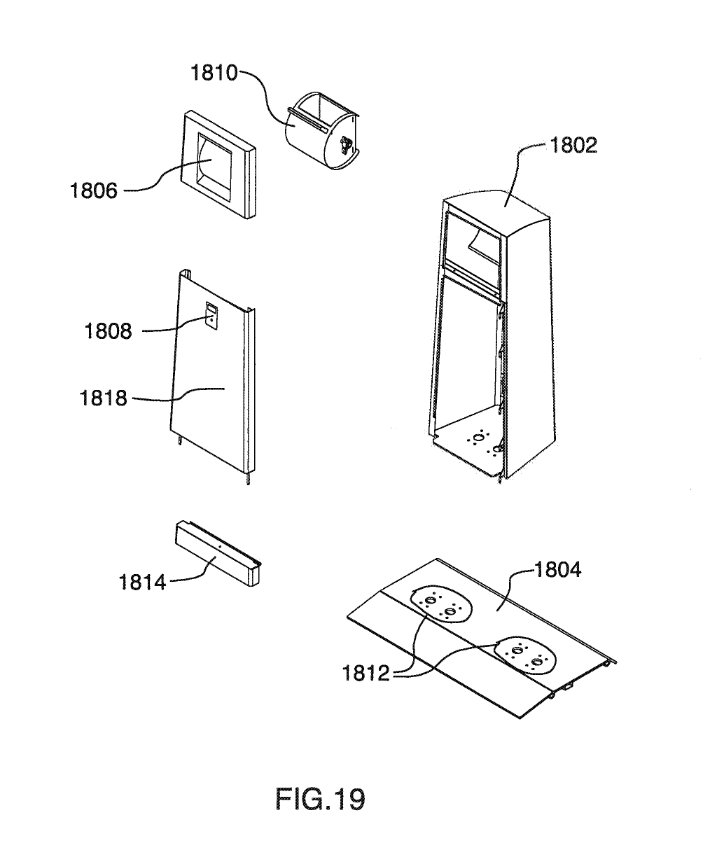

As shown in FIG. 19, the helmet collecting station 1800 comprises the access door 1806, the frame 1802, a drum 1810 rotatably mounted in the frame 1802, a vertical panel 1818 and a vertical bottom member 1814.

The skilled addressee will appreciate that various alternative embodiments may be provided.

It will be appreciated that the control panel 1808 is mounted on the vertical panel 1818.

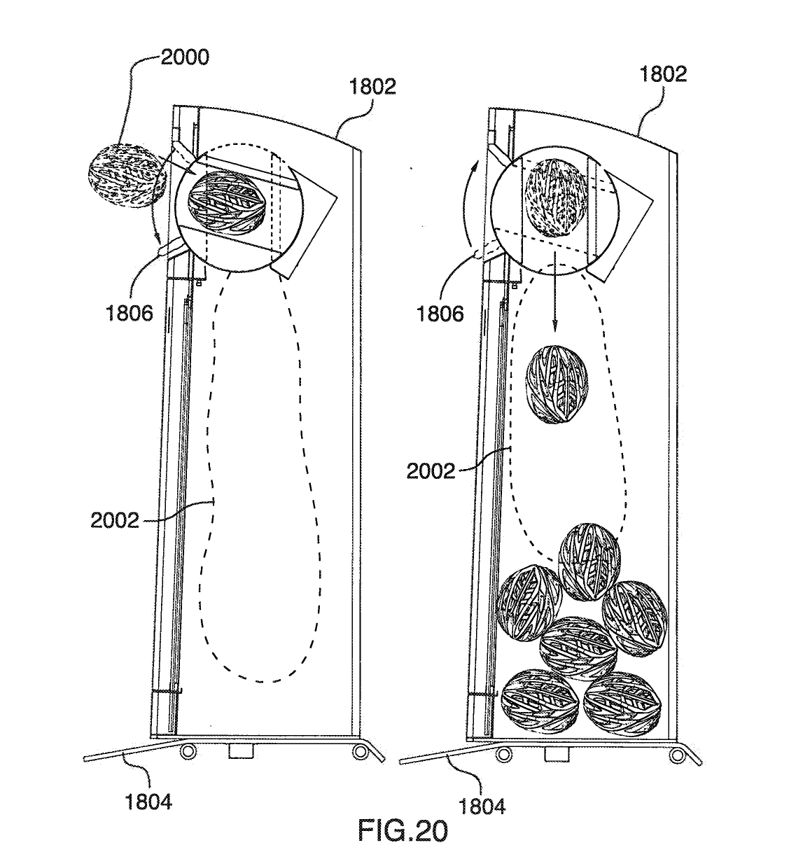

As shown in FIG. 20, the access door 1806 is first opened and the helmet is inserted into a cavity defined in the drum 1810. Once the access door 1806 is dosed, the drum 1810 is rotated, which causes the helmet to fall into a helmet chute.

While this is not shown, it will be appreciated by the skilled addressee that from time to time an operator may open the helmet collecting station 1800 and remove the plurality of helmets located inside it.

While this has not been shown in the figures, it will be appreciated that the helmet collecting station 1800 further comprises means for identifying a helmet inserted into the drum 1810. In one embodiment, the means for identifying a helmet inserted into the drum 1810 comprises RFID readers adapted for reading a corresponding RFID tag.

The helmet collecting station 1800 further comprises means for selectively locking/unlocking the access door 1806.

The helmet collecting station 1800 further comprises means for transmitting data to the remote processing unit, the data comprising at least an identification of the helmet inserted in the drum 1806.

The skilled addressee will appreciate that the helmet collecting station 1800 may be provided in various alternative forms.

Although the above description relates to a specific embodiment as presently contemplated by the inventor, it will be understood that the invention in its broad aspect includes mechanical and functional equivalents of the elements described herein.

1. A method for providing a helmet to a user, the method comprising:
receiving a request from a user for performing one of renting and buying a helmet, the request comprising an indication of a size for the helmet;
determining if the request can be met by a helmet dispensing apparatus;
authenticating the user; and
if said authentication is successful, the helmet dispensing apparatus providing the user with a helmet in accordance with the request, the helmet comprising an identification element, the providing comprising associating the identification element of the helmet provided with the user.

2. A method according to claim 1, wherein said step of authenticating a user comprises one of obtaining a unique user identifier or obtaining payment for said helmet.

3. A method according to claim 2, wherein said unique user identifier is information stored on a smart card, information stored on a subscriber key, or a unique user D.

4. A method according to claim 1, wherein said step of receiving a request comprises providing a kiosk, wherein said user interacts with said kiosk to formulate said request.

5. A method according to claim 4, wherein said helmet dispensing apparatus is operatively connected to said kiosk.

6. A method according to claim 4, wherein said kiosk is integrated into said helmet dispensing apparatus.

7. A method according to claim 1, wherein said helmet is provided with a unique identifier, and wherein said step of providing the user with a helmet includes the sub step of said helmet dispensing apparatus obtaining said unique identifier, and storing said identifier with said authentication of said user.

8. A method according to claim 7, wherein said unique identifier of said helmet is an RFID tag, and wherein said sub step of obtaining said unique identifier includes reading said RFID tag.

9. A method according to claim 1, wherein said user request includes a request of a size of said helmet, said method including the step of determining is said size helmet user be met.

10. A helmet providing unit, said helmet providing unit comprising:
a plurality of helmets, and an interface for receiving from a user a request to rent or purchase one of said plurality of helmets;
an authorizing module for authorizing said user to purchase or rent said helmet;
a helmet dispenser for dispensing said helmet when said user has been authorized.

11. A helmet providing unit according to claim 10, wherein said interface further includes a card reader.

12. A helmet providing unit according to claim 10, wherein said unit is initially provided with helmets of at least two different sizes, and wherein said user using said interface, specifies one of said at least two different sizes.

13. A helmet providing unit according to claim 10, wherein each helmet is provided with a unique identifier.

14. A helmet providing unit according to claim 3, wherein said helmet dispenser includes a tag reader, and wherein said unique identifier of each of said helmets is a tag.

15. A helmet providing unit according to claim 4, wherein said tag is an RFID tag.

16. A system for providing helmets to users, said system comprising:
a plurality of helmet providing units geographically distributed in an area;
said helmet providing units being adapted to receive a report from a user to rent or purchase a helmet; each of said units being in communication with a remote location and with each other directly or through said remote location, said helmet providing units being provided with a user interface and an authorizing module;
said helmet providing units including a dispenser for dispensing a helmet when a user has been authorized;
said system further including at least one helmet collecting station.

17. A system according to claim 16, wherein each helmet is provided with an image identifier and wherein said helmet dispensing unit is adapted to obtain said unique identifier when dispensing said helmet, and storing said identifier with said authorization of said user, and said helmet collecting station being adapted to obtain said unique identifier when said user returns said helmet, said helmet collecting station being in communication with said remote location and being adapted to transmit said unique identifier to said remote location.

18. A system according to claim 17, wherein said unique identifier is an RFID tag.

19. A system according to claim 16, wherein said system is integrated with a bicycle rental system, and wherein a plurality of helmet dispensing station are integrated with some bicycle rental stations and wherein at least one bicycle rental station is provided with a helmet collecting station.
